(19) United States
(12) Patent Application Publication
(10) Pub. No.: US 2016/0180798 A1
(43) Pub. Date: Jun. 23, 2016

(54) SYSTEMS, METHODS, AND DEVICES FOR CONTROLLING CONTENT UPDATE RATES

(71) Applicant: Elwha LLC, Bellevue, WA (US)

(72) Inventors: Steven Bathiche, Kirkland, WA (US); Jesse R. Cheatham, III, Seattle, WA (US); Paul H. Dietz, Redmond, WA (US); Matthew G. Dyor, Bellevue, WA (US); Philip A. Eckhoff, Kirkland, WA (US); Anoop Gupta, Woodinville, WA (US); Kenneth P. Hinckley, Redmond, WA (US); Roderick A. Hyde, Redmond, WA (US); Muriel Y. Ishikawa, Livermore, CA (US); Jordin T. Kare, Seattle, WA (US); Craig J. Mundie, Seattle, WA (US); Nathan P. Myhrvold, Bellevue, WA (US); Andreas G. Nowatzyk, San Jose, CA (US); Robert C. Petroski, Seattle, WA (US); Danny Allen Reed, Iowa City, IA (US); Clarence T. Tegreene, Mercer Island, WA (US); Charles Whitmer, North Bend, WA (US); Lowell L. Wood, JR., Bellevue, WA (US); Victoria Y.H. Wood, Livermore, CA (US)

(21) Appl. No.: 14/579,138

(22) Filed: Dec. 22, 2014

(51) Int. Cl. G09G 5/00; G06F 3/044; G06F 3/01

(52) U.S. Cl. CPC G09G 5/003; G06F 3/013; G06F 3/044; G06F 2203/04104

(57) ABSTRACT

A display system includes a display, a focus region component, a content update component, and a content component. The focus region component is configured to determine a focus region of a user in relation to a display screen of the display. The focus region includes a region of the display screen at which a user is likely looking. The content update component is configured to select content update rates for a plurality of display regions of the display screen, including the focus region. The content update rate in the focus region is different than a content update rate in one or more other display regions of the plurality of display regions. The content component is configured to receive content and updated content for display on the display screen and to provide the content to the display based on the content update rates.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

None.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### BRIEF DESCRIPTION OF THE FIGURES

FIG. 1 is a schematic block diagram of a system for refreshing a display.

FIG. 2 is a schematic block diagram of a display having a plurality of display regions.

FIGS. 3A-3D are schematic diagrams illustrating example display regions of display screen.

FIG. 4 is a perspective view of a display used for stylus input.

FIG. 5 illustrates a screenshot of a drawing program with a current focus region.

FIG. 6 illustrates a screenshot of a word processing program with a current focus region.

FIG. 7 illustrates a screenshot of a web browser with a current focus region.

FIG. 8 illustrates a screenshot of a mobile interface with a current focus region.

FIG. 9 illustrates a screenshot of another mobile interface with a current focus region.

FIG. 10 is a schematic flow chart diagram illustrating a method for refreshing a display.

FIG. 11 is a schematic flow chart diagram illustrating a method for updating content for display.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Displays utilize a variety of display technologies to present images, text, video, or other content for viewing by users. For example, computers, televisions, telephones, tablets, and numerous other devices display content on displays that use one or more of a liquid crystal display (LCD), cathode ray tube (CRT), organic light-emitting diode (OLED), digital light processing (DLP), or other display technology. Generally, display elements of displays are periodically refreshed or updated to improve image quality or allow for video or other changing content. Refresh rates for display screens describe the rate at which the overall picture of the display is refreshed and/or the rate at which display elements (e.g., pixels) are refreshed. Generally, higher refresh rates allow for better viewing experience including displaying more dynamic content. For example, users generally find higher refresh rates to be easier on their eyes and to improve smoothness in video or other content that displays motion. However, higher refresh rates also require a larger amount of energy. Furthermore, higher refresh rates may also often require a greater amount of content, memory storage, or processing. For example, a display that is refreshed at twice a previous rate may require twice as much processing to produce twice as many effective images.

Applicant has recognized a need for adjusting refresh rates and content update rates for visual content. In one embodiment, the present application discloses systems, methods, and devices to adjust screen refresh rates to be higher where the user is looking (focusing) and lower where the user is not focusing. For example, a system may vary a screen refresh rate or a content update rate based on where a pen input is. For instance, a system may rapidly refresh a region near an input object, such as a pen or finger, but refresh other regions less frequently. In one embodiment, a refresh region near a touch or input location may be refreshed at a first rate while another region is refreshed at a different rate. For example, a device may rapidly refresh a region near a touch location, but refresh other regions less frequently. Similarly, a device may refresh regions near a touch location less frequently than other locations. In touch screen situations, touches may be by a pen/stylus, finger, or other input object. Touch screens may also be multi-touch screens.

According to one embodiment, display system includes a display, a focus region component, a content update component, and a content component. The focus region component is configured to determine a focus region of a user in relation to a display screen of the display. The focus region includes a region of the display screen at which a user is likely looking. The content update component is configured to select content update rates for a plurality of display regions of the display screen, including the focus region. The content update rate in the focus region is different than a content update rate in one or more other display regions of the plurality of display regions. The content component is configured to receive content and updated content for display on the display screen and to provide the content to the display based on the content update rates.

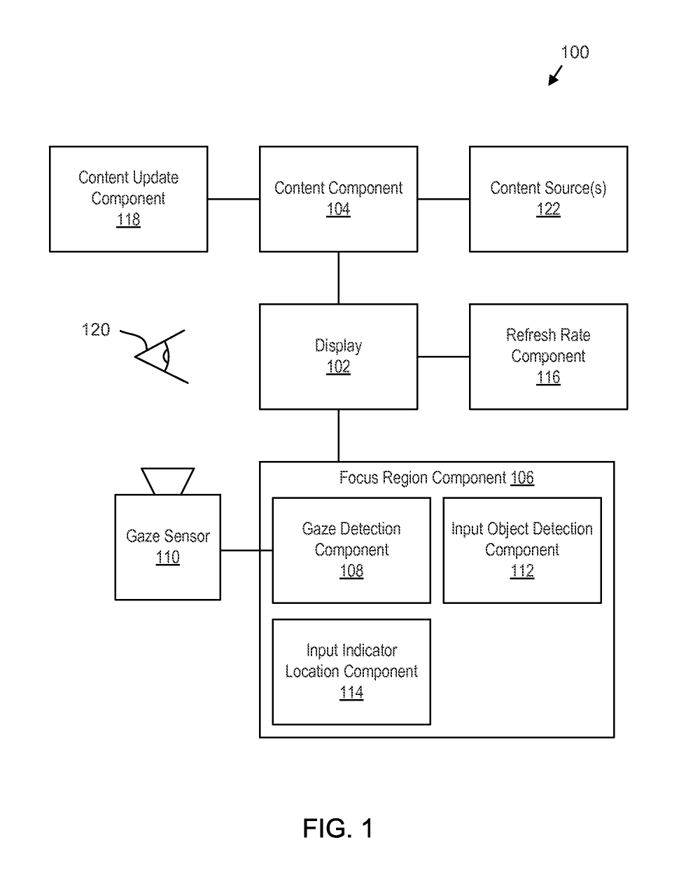

FIG. 1 is a schematic block diagram of a display system 100. The display system 100 may include a display system for one or more of a computer, computer monitor, television, touch screen monitor, tablet computer, cellular phone, all-in-one computing device, or the like. The display may include a touch screen or multi-touch screen display such as a capacitive or pressure sensitive touch screen. The display system 100 includes a display 102. The display 102 may include one or more display elements. The display elements may include one or more pixels or other display elements that have an independently adjustable color and intensity to form part of an image on the display 102. In one embodiment, the display 102 is configured to selectively display information with refresh rates that vary across a plurality of display regions of a display screen. For example, the refresh rates correspond to a frequency at which display elements within the plurality of display regions are refreshed.

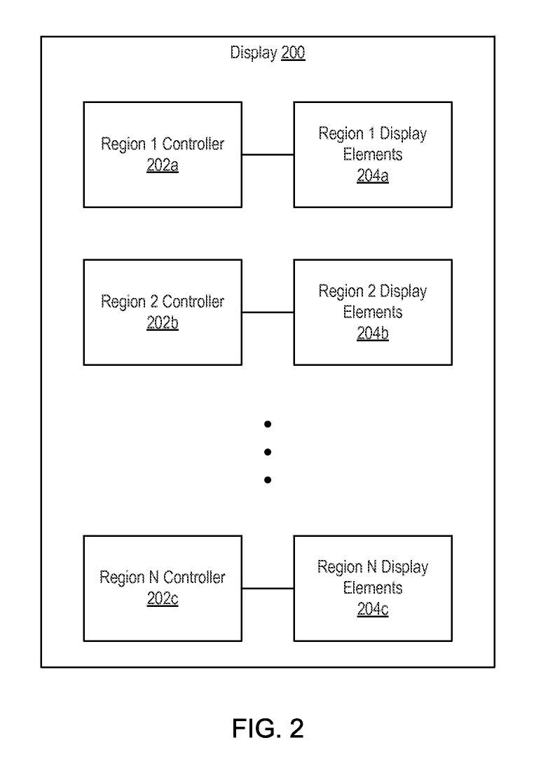

In one embodiment, the display 102 is logically or operationally divided into a plurality of display regions. FIG. 2 is a schematic block diagram illustrating components of a multi-region display 200. For example, the display 102 of FIG. 1 may include the multi-region display 200. The multi-region display 200 includes a plurality of region controllers 202a, 202b, 202c and display elements divided into N display regions, wherein N is the number of display regions of the multi-region display 200. The region controllers include a region 1 controller 202a that controls region 1 display elements 204a, a region 2 controller 202b that controls region 2 display elements 204b, and a region N controller 202c that controls region N display elements 204c. In one embodiment, the region controllers 202a, 202b, 202c control a refresh rate of each display region. For example, the region 1 controller 202a may refresh the region 1 display elements 204a at a refresh rate different than a refresh rate used by the region 2 controller 202b to refresh the region 2 display elements 204b. In one embodiment, the number N of display regions may provide a hardware limitation on how the display 200 may be divided into different display regions. In one embodiment, a display 200 divided into a plurality of static display regions (e.g., hardware limited display regions) may be used to provide two or more dynamic display regions. For example, different display regions may be grouped together by refresh rate to effectively allow dynamic shaping and selection of display regions with an increased or decreased refresh rate.

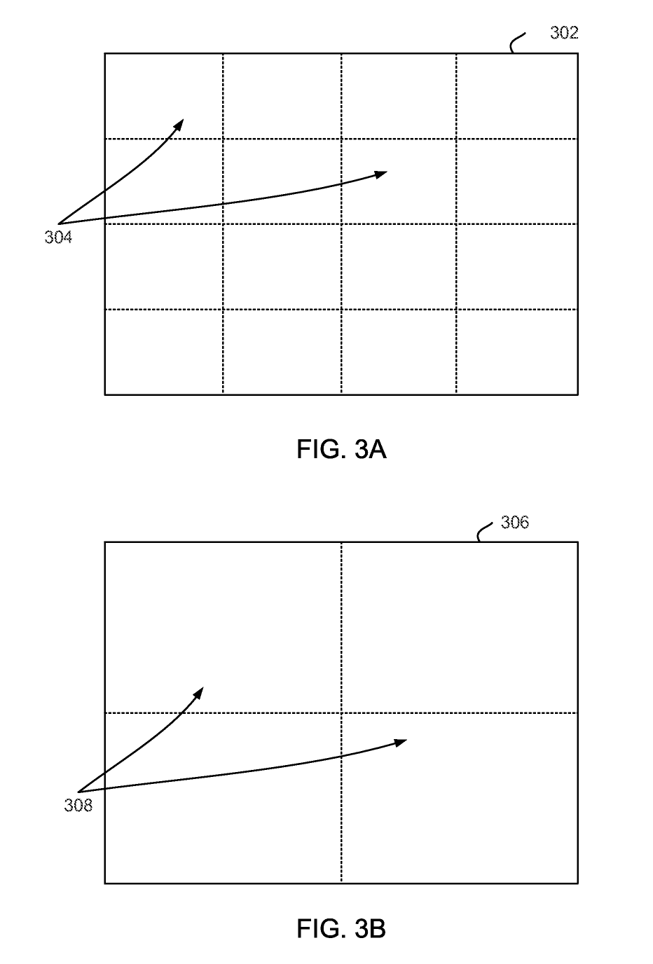

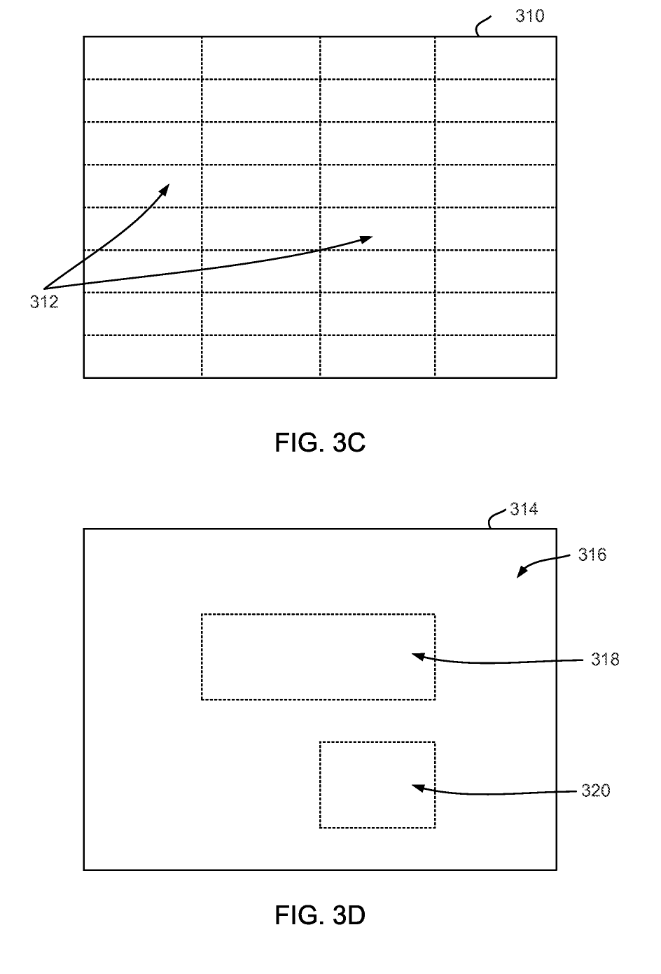

FIGS. 3A-3D illustrate division of a display screen into display regions, according to varying embodiments. FIG. 3A illustrates a display screen 302 divided into 16 equally sized display regions 304. In one embodiment, each display region 304 may have a corresponding region controller (e.g., the region controllers 202a-202c of FIG. 2). FIG. 3B illustrates a display screen 306 divided into four equally sized display regions 308. FIG. 3C illustrates a display screen 310 divided into 32 equally sized display regions 312. The display regions 312 each have an elongated horizontal dimension. FIG. 3D illustrates a display screen 314 divided into a first display region 316, a second display region 318, and a third display region 320. In one embodiment, the display regions of FIGS. 3A-3C may represent hardware or operational display regions. For example, each display region 312 of FIG. 3C may have its own region controller to allow it to have an independently selected refresh rate. In one embodiment, one or more of the display regions of FIGS. 3A-3D may represent dynamic or logical display regions. For example, each display region 308 of FIG. 3B may be a logical display region that includes a plurality of the display regions 304 of FIG. 3A that are operated to act as a single display region. For example, a display screen with N display regions may by dynamically adjusted to act like a display screen having from one to N display regions by making some regions have the same refresh rate and thus operate as a single display region.

In one embodiment, the display regions 316, 318, 320 of FIG. 3D include dynamic display regions that are each made up of one or more display regions 312 of FIG. 3C. For example, the second display region 318 may include four display regions 312, the third display region 320 may include two display regions 312, and the first display region 316 may include the remaining 26 display regions 312 of FIG. 3C. In one embodiment, dynamic display regions may be periodically reselected or redefined based on a focus location of a user. For example, the display 102 may determine or select a shape and location of one or more of the dynamic display regions on the display screen based on a current focus region of a user.

In one embodiment, each display element may be separately addressable or refreshable. For example, each display element may be able to have its own refresh rate independent of refresh rates of other display elements. Independently selectable display elements (or pixels) may allow unlimited grouping of display elements to produce focus regions of any shape or size.

Returning to FIG. 1, a content component 104 provides content to the display 102 for display on a display screen. For example, the display 102 may display the content within one or more display regions of the display 102. In one embodiment, the content component 104 receives the content from a content source 122 such as a storage device, network connection, graphics processor (e.g., a graphics card), or other source. In one embodiment, the content component 104 may identify a type of content provided to the display 102. For example, the content may include text, images, video, advertisements, or other visual content. In one embodiment, the content may be identified based on a file type, format type, or program type. For example, content may be identified as web content, word processing content, video player content, or the like. In one embodiment, content within a program or window may be identified as corresponding to different content types. For example, if the display 102 is displaying a web page, the content component 104 may identify a portion of the content as text and another portion of the content as video, images, or advertisements. In one embodiment, the content component 104 may identify a display region for each content type. For example, the content component 104 may identify one or more content types for content sent to each region controller (e.g., region controllers 202a-202c of FIG. 2).

In one embodiment, the content component 104 may periodically refresh content or may receive refreshed content from the content source 122. In one embodiment, the content component 104 may refresh content based on a refresh rate or content update rate of a specific display region. For example, the content component 104 may refresh content by providing new or updated content for one display region at a different content refresh rate than for a different display region. The content component 104 may refresh or update content for a specific display region based on one or more of a content update rate determined by a content update component 118 or a refresh rate determined by a refresh rate component 116.

A focus region component 106 is configured to determine a focus region of a user in relation to the display 102. For example, the focus region component 104 may determine where on a display screen the user is currently likely looking or where the user's eyes are likely focused. In one embodiment, determining a focus region of the user may allow the system 100 to intelligently allocate resources for what the user is currently focusing on. For example, display elements or content in one region may be refreshed at a different rate than the rest of the display because the user is focusing on that region. In a video game embodiment, a user's character may be fighting with an opposing character. Since the user is likely to be closely observing the opposing character during the fight, the focus region may be determined to encompass the opposing character, or a portion of it (e.g., its hands, or its weapon). In another video game embodiment, the focus region may encompass an aim point of a user's weapon (e.g., a region surrounding crosshairs of a gun aimed by the user's character).

The focus region component 106 may determine the focus region based on a variety of different factors. For example, the shape of the focus region may be based on a location or movement of an input object, input method, content type, or the like. In one embodiment, the focus region component 106 may select a focus region that includes one or more static display regions. In one embodiment, the focus region component 106 may select or determine focus regions that have a symmetrical shape or an asymmetrical shape. For example, the focus region component 106 may determine a focus region that has a width greater than a height. As a further example, the focus region component 106 may select a focus region having an asymmetrical shape with a longer dimension along a direction of movement of one or more of an input object and an input indicator.

The focus region component 106 may determine the current focus region in a variety of manners. In one embodiment, the focus region component 106 includes a gaze detection component 108 to determine the focus region by detecting a gaze direction of a user. For example, the gaze detection component 108 may observe one or more of a user's eyes to determine which direction the user is looking and thereby determine which display region(s) are in focus or are being looked at by the user. For example, the gaze detection component 108 may determine an angle of the gaze direction in relation to the display. The gaze detection component 108 may receive image, video, infrared, or any other sensor data from a gaze sensor 110. For example, the gaze sensor 110 may include a camera that is directed toward an eye 120 of a user and thereby observe a direction of the user's gaze.

The focus region component 106 may include an input object detection component 112 to detect an input object, or a location of an input object, in relation to the display 102. For example, the input object detection component 112 may detect a location of a finger or stylus in relation to the display 102. In one embodiment, the display 102 includes a touch screen and the focus region component 106 may detect a touch or proximity of a finger or stylus. The input object detection component 112 may determine the location of the touch or movement of the input object. In one embodiment, the focus region component 106 may identify a focus region as one or more display regions that correspond to a location of the detected input object. For example, users may usually look at or near a location that they are touching on the screen with their finger or a stylus/pen.

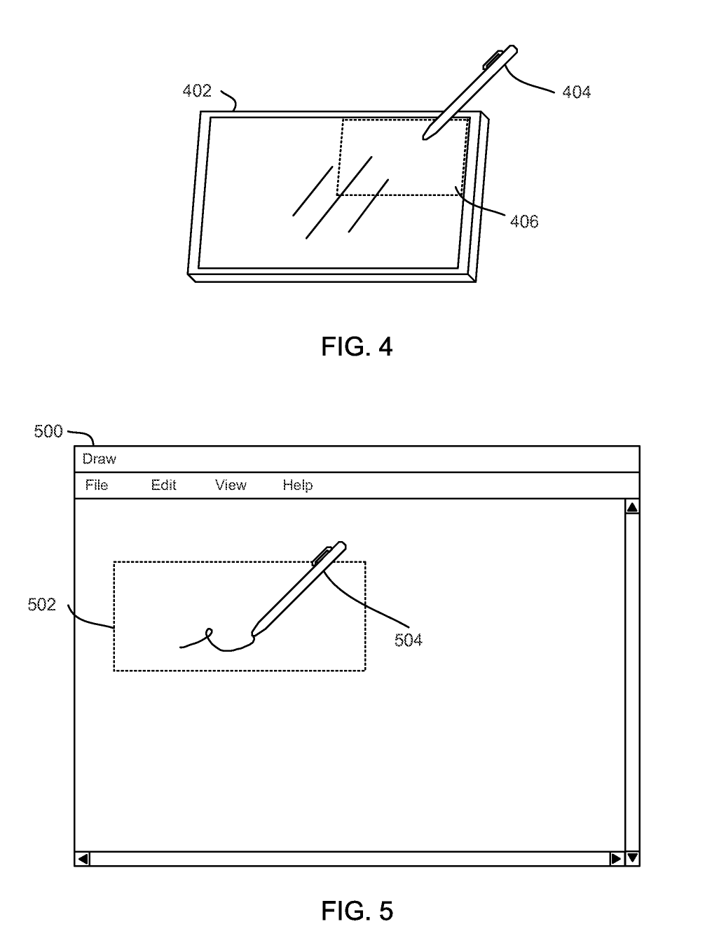

FIG. 4 illustrates one embodiment of a display 402 and a stylus 404. The stylus 404 may be used as an input object to write, select graphical buttons or options, or provide other input on the display 402. In one embodiment, the input object detection component 112 may detect the location of the stylus 404 (or tip of the stylus 404) and the focus region component 106 may identify one or more display regions at or near the location of the stylus as a current focus region 406. Similarly, a finger or any other object may be used as an input object to the display 402, depending on sensing technology. For example, capacitive touch screens may select a plurality of different objects which are placed proximally to a display while light pen technology may only detect a tip of the stylus 404. In one embodiment, the display 402 may include a computing device, such as a table computer, that includes a plurality or all of the components of the system 100 of FIG. 1.

FIG. 5 illustrates a screenshot of a drawing program window 500 and a stylus 504 being used to draw. The stylus 504 is shown drawing a line in the window 500. In one embodiment, the input object detection component 112 detects a current location of the stylus 504 and the focus region component 106 determines a focus region 502 comprising one or more display regions. In one embodiment, the focus region component 106 selects an oblong horizontal display region because the stylus 504 is moving in a generally horizontal direction.

Returning to FIG. 1, in one embodiment, the focus region component 106 includes an input indicator location component 114 that determines a location of an input indicator displayed on the display 102. For example, the input indicator may indicate a location for input on the display 102. Example input indicators include a mouse pointer, a text cursor, an indication that an on-screen button or cell is currently selected for input, or the like. In one embodiment, the focus region component 106 may identify a focus region as one or more display regions that correspond to a location of one or more input indicators. For example, users may usually focus on or near a location of an input indicator while typing, using a mouse, or the like.

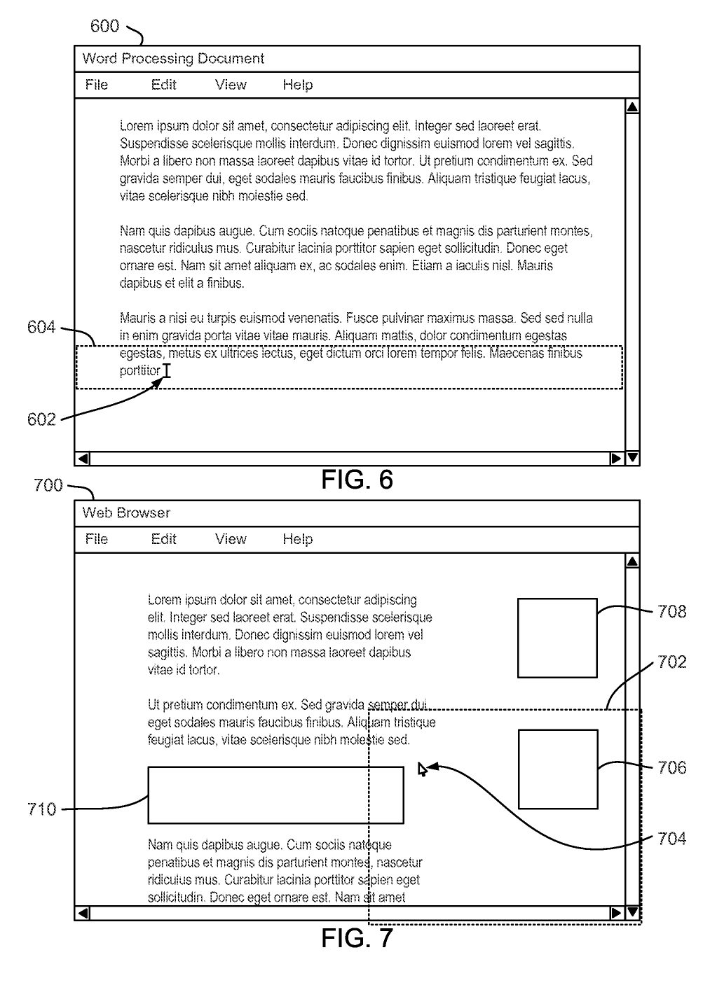

FIG. 6 illustrates a screenshot of a word processing program window 600 illustrating a text cursor 602 used to input text. The input indicator location component 114 may identify the location of the text cursor 602 by interfacing with an operating system, and the focus region component 106 may select a focus region 604 that includes one or more display regions including and/or near the text cursor 602. For example, the focus region 604 may include four display regions 312 of FIG. 3C. In one embodiment, the focus region component 106 may receive an indication from the content component 104 that the content near the text cursor 602 includes text or word processing content. The focus region component 106 may select the focus region 604 based on the content type. In one embodiment, the focus region component 106 may select the horizontally oblong focus region 604 because change in a word processing document occurs generally on or near a current line of the text cursor 602 (e.g., during typing, etc.). For example, the focus region 604 covers a row of text where the cursor is placed and where typing, formatting, or other changes are most likely to take place and/or be noticed by a user.

In one embodiment, the focus region component 106 may determine a current focus region based on predicted area of focus of a user. For example, the focus region component 106 may predict where on the display 102 a user will focus based on previous use, current context, or the like. In one embodiment, the focus region component 106 may predict a future or current focus location based on where an input object or input indicator has previously been located. For example, a user may usually make a first on-screen selection followed by a second on-screen selection. Thus, after a user makes the first on-screen selection, the focus region component 106 may select a region corresponding to the second on-screen selection as a current or future focus location. Similarly, focus regions can be selected based on previous touches on a touch screen, previous inputs using a mouse or keyboard, or the like. In one embodiment, the focus region component 106 selects a focus region based on a predicted movement of an input object. For example, the focus region component 106 may predict that a stylus will be used to write text and may move in a generally horizontal direction or that a finger swipe will be used to scroll a web-page. The focus region component 106 may then select a focus region based on the predicted movement. In one embodiment, the focus region component 106 may detect a direction and speed of input with a stylus or other input object and select a focus region having a greater dimension in the direction of the movement.

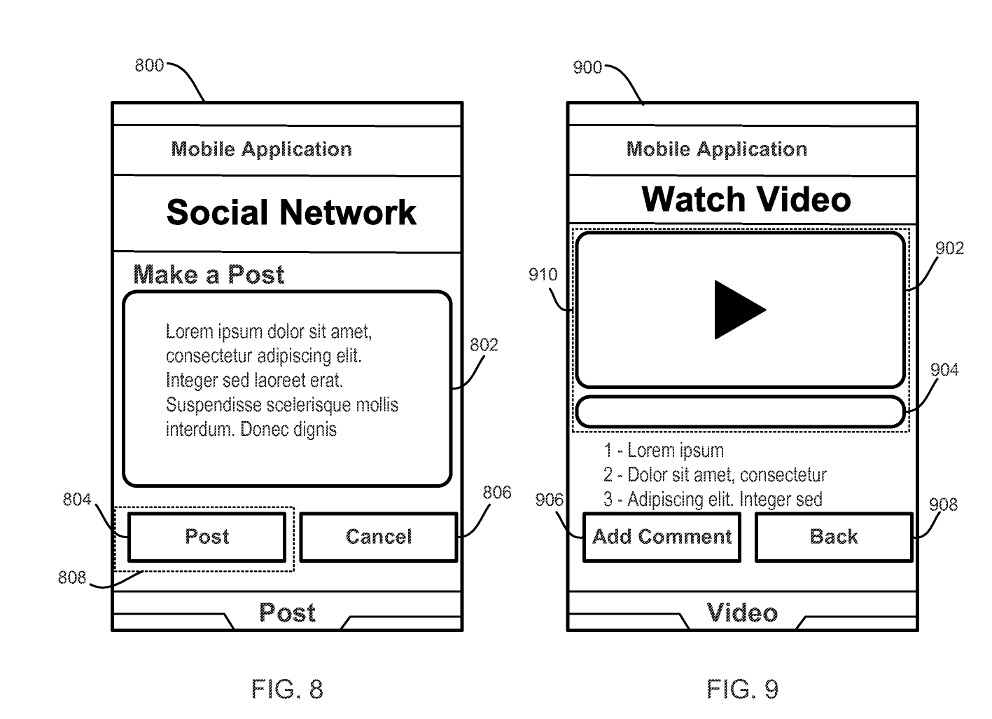

FIG. 8 illustrates a “make a post” interface 800 of a social network application on a mobile device, such as a smartphone or tablet computer. The interface 800 includes a text entry field 802, a post option 804, and a cancel option 806. A user may be able to input text in the text entry field 802 using a touch screen keyboard. The post option 804 may post any text in the text entry field 802 to a user's account, and the cancel option 806 may cancel the post. In one embodiment, the post option 804 and the cancel option 806 are options that present an animation (e.g., an animated button or other graphical change) upon selection. The interface 800 shows a state of the application after a user has entered text and closed an on-screen keyboard.

In one embodiment, the focus region component 106 may select a focus region based on the current interface state, the fact that text has been entered in the text entry field 802, and/or the fact that the on-screen keyboard has been closed. For example, the focus region component 106 may predict that the post option 804 will be selected next because it is usually selected after text has been entered and a keyboard has been closed. Thus, the focus region component 106 may select a focus region 808 corresponding to the post option 804. In one embodiment, the focus region component 106 may select a focus region based on available on-screen options. For example, a user may only be able to provide input in the entry field 802, the post option 804, and the cancel option 806. Thus, the focus region component 106 may select a focus region that includes the entry field 802, the post option 804, and the cancel option 806 and excludes at least a portion of the rest of the screen.

FIG. 9 illustrates a “Watch Video” interface 900 of a video application on a mobile device. The interface 900 includes a video display region 902, an advertisement region 904, an add comment option 906, and a back option 908. Video content may be displayed in the video display region 902 while advertising content may be displayed in the advertisement region 904. A user may select the add comment option 906 to provide a comment on the video (e.g., a shared comment) and or select the back option 908 to return to a previous video or view.

In one embodiment, the focus region component 106 may select a focus region based on whether a video is being played in the video display region 902. For example, the focus region component 106 may predict that a user is not focusing on the video display region 902 until the user selects an option to begin playing the video (e.g., by touching the video display region 902). Rather, the focus region component 106 may predict that the user is more likely to be focusing on the add comment option 906 or the back option 908 and may select a focus region that includes the add comment option 906 or the back option 908. However, if the video begins playing, the focus region component 106 may select a focus region that includes the video display region 902. In one embodiment, the focus region component 106 may determine that the focus region also includes the advertisement region 904 because of its proximity to the video display region 902. A focus region 910 is shown including both the video display region 902 and the advertisement region 904. For example, the focus region component 106 may select the focus region 910 when a video begins to play in the video display region 902.

Returning to FIG. 1, the refresh rate component 116 selects refresh rates for different regions of the display 102. In one embodiment, the refresh rate component 116 selects refresh rates such that a refresh rate in a focus region (e.g., selected by the focus region component 106) is different than a refresh rate in one or more other display regions of the plurality of display regions. For example, the refresh rate component 116 may select a first refresh rate for a focus region and a second refresh rate for regions of the display not corresponding to the focus region. In one embodiment, the refresh rate component 116 selects the refresh rates from a predefined list of refresh rates. For example, the predefined list of refresh rates may include refresh rates supported by one or more of hardware, software, or firmware of the display 102 or the system 100. For example, displays using different display technologies may have limitations on a highest or lowest refresh rate while still providing acceptable images. In one embodiment, the predefined list of refresh rates may include specific refresh rates based on content type. For example, each content type may include two or more different refresh rates corresponding to whether or not the content is in a focus region. In one embodiment, the predefined list of refresh rates may be stored in a storage device of the system 100.

The refresh rate component 116 may select the refresh rate for different display regions, or display elements corresponding to display regions, based on the current focus region determined by the focus region component 106. In one embodiment, the refresh rate component 116 selects the refresh rate in the focus region to be higher than the refresh rate in the one or more other display regions of the plurality of display regions. For example, the higher refresh rate may result in increased display quality (or perceived display quality) in the focus region. Because the focus region may be where a user is looking, this may provide a better user experience to the user while reducing the refresh rate requirement in areas where the user is not looking. In one embodiment, the refresh rate component 116 selects the refresh rate in the focus region to be less than the refresh rate in the one or more other display regions of the plurality of display regions. For example, the display screen may be a touch screen where display elements in the focus region are covered by an input object. Because the focus region may be obscured, it may be unnecessary to refresh at the same rate.

In one embodiment, the refresh rate component 116 selects refresh rates of the display elements to satisfy a refresh effort constraint. For example, the refresh effort constraint may be a maximum value for the sum of products of refresh rate times number of pixels at that rate. As an example, a refresh rate effort for each region may be determined by multiplying a refresh rate by the number of display elements of the region. Then the refresh rate efforts may be summed to arrive at an overall refresh effort. The refresh effort constraint may reflect a hardware limitation, energy consumption limitation, processing effort, or other limitation on the system 100 or the display 102 that should be met. For example, it may be undesirable to have all the display elements of a display running at an extremely high frequency due to energy consumption, processing power, and/or heat dissipation. In one embodiment, the refresh rate component 116 may increase at least one refresh rate in the focus region and decrease at least one refresh rate in one or more other display regions in order to satisfy the refresh effort constraint.

In one embodiment, the refresh rate component 116 selects refresh rates based on a content type displayed in a display region of the display 102. For example, the refresh rate component 116 may select a refresh rate for a specific display region (e.g., a focus region) based on one or more content types for the specific display region identified by the content component 104. In one embodiment, the refresh rate component 116 may select a higher refresh rate for more dynamic content types while selecting lower refresh rates based on less dynamic or static content types. For example, text on a webpage or in a word processing document may be less dynamic than video or animated content. In one embodiment, the refresh rate component 116 selects a refresh rate for a specific region based on the most dynamic content type. For example, if a display region will include text and video content, the refresh rate component 116 may select a higher refresh rate due to the presence of the video content. On the other hand, if the display region only includes text content, a lower refresh rate may be used while still providing similar apparent image quality to a user. In one embodiment, the refresh rate component 116 may reselect refresh rates each time a focus region or content type changes.

In one embodiment, the refresh rate component 116 may select a refresh rate that is at least as fast as a content update rate selected by the content update component 118. For example, if content displayed within a focus region is updated at a specific frequency, the refresh rate component 116 may select a refresh rate such that the focus region is refreshed at least as often as the content update rate. In some embodiments, the content update rate may be reduced to match a refresh rate.

With regard to FIGS. 5-9 example refresh rate selection will be discussed. In FIG. 5, the refresh rate component 116 may select a higher refresh rate for the focus region 502 while selecting a relatively low refresh rate for the remainder of the display. For example, the refresh rate component 116 may select a highest available refresh rate in the focus region 502 to allow for quicker response to drawing using the stylus 504. Because other regions of the drawing program window 500 may experience little, if any, change during drawing, the remainder of the display may have a minimum refresh rate.

In FIG. 6 the focus region 604 corresponds to typing at the location of the text cursor 602. In one embodiment, the refresh rate component 116 may select a high refresh rate for the focus region 604 while selecting a lower refresh rate for the remainder of the window 600. In one embodiment, the high refresh rate for the focus region 604 may be less than for video or other dynamic content but may be higher than for static content that is not in focus. For example, it may be desirable to refresh content in the focus region 604 at a sufficiently high rate that a user does not detect any lag between typing and the appearance of typed characters. For other regions of the display, few, if any, changes may occur and may be out of focus when a user is looking at the text cursor 602. For example, even if changes occur outside a focus region, the user may be unlikely to notice if the user is looking in the focus region.

In FIG. 7 a focus region 702 includes a quarter of a display where a mouse cursor 704 is located. The refresh rate component 116 may select a high refresh rate for the focus region 702 while selecting a low refresh rate for the rest of a window 700. In one embodiment, the refresh rate component 116 may select the refresh rates due to a type of content shown in the window 700. Specifically, the window 700 is shown with text, a first content area 706, a second content area 708, and a third content area 710 which may include different types of content. In one embodiment, if the first content area 706 displays animated advertising content the refresh rate component 116 may select a higher refresh rate than if the first content area 706 displays a static image. In one embodiment, the second content area 708 may be refreshed at a lower refresh rate even if it displays video because it is outside of the focus region 702. In one embodiment, the type of content of the third content area 708 may affect the refresh rate of the focus area 702 because it is partly within the focus area. In one embodiment, only the portion of the third content area 708 that is within the focus region 702 is displayed with the higher refresh rate of the focus region 702.

In FIGS. 8 and 9, the refresh rate component 116 may select an elevated refresh rate for the focus regions 808 and 910 while selecting reduced refresh rates for other portions of the interfaces 800, 900. In one embodiment, the refresh rate component 116 selects the elevated refresh rate and the reduced refresh rate to satisfy a refresh rate constraint that limits power consumption of a mobile display.

Returning again to FIG. 1, a content update component 118 is configured to select a content update rate for display regions of the display 102. The term content update rate is given to reference how frequently content for display is updated. For example, updating content may include one or more of: retrieving a next image for a video or animation from memory for display; requesting updated content from a website or program; and calculating a new image or visual content using a graphics card or processor. Updated content may indicate that the content for display has changed or has been recalculated. For example, a video displayed at 60 Hertz (Hz) may show a new image every 1/60th of a second while a video displayed at 120 Hz may show a new image every 1/120th of a second. Thus, the content itself may actually be changing. On the other hand, code for an animation or program may be processed by a graphics card to compute a new image at the content update rate. Although the image may not change for each update period, the graphics card may be processing data to compute/determine the new image.

The content update component 118 may select content update rates for the focus region and other regions of the display 102. In one embodiment, the content update component 118 selects a first content update rate for the focus region and a second content update rate for the remaining display regions of the display 102. For example, the content update rate in the focus region may be different than a content update rate in one or more other display regions of the display screen 102. In one embodiment, the content update component 118 selects the content update rate in the focus region to be less than the content update rate in the one or more other display regions of the plurality of display regions. For example, the focus region may correspond to a touch on the display 102 and thus may be obscured by a user's finger or other input object. As a further example, the focus region may include cycling advertisements, and a rate of switching advertisements may be reduced or stopped while the focus region includes the advertisements. For example, the content update component 118 may reduce or stop the content update rate while the user is focusing in the display region and then increase the content update rate when the user looks away to continue cycling through the advertisements. With regard to gaze detection, this may have the effect of locking a static advertisement in the focus region (for at least a period of time) once the user looks in that region and then releasing the lock when the user looks away.

In one embodiment, the content update component 118 selects the content update rate in the focus region to be higher than the content update rate in other display regions of the display 102. In one embodiment, the content update component 118 selects a content update rate to update content, such as video or advertisements, displayed in the focus region more frequently than content in other display regions. In one embodiment, the content update component 118 selects a content update rate to update contents of a word processing document displayed near an input indicator more frequently than contents of the word processing document displayed in one or more other display regions away from the input indicator. For example, a location where text is being input or formatted may be updated more frequently than other regions of the display where no typing or input is occurring. In touch screen embodiments, the content in or near the touch location may be rapidly updated, while content further away from the touch location may be more static.

In one embodiment, the content update component 118 is configured to select the content update rates from a predefined list of update rates. For example, the predefined list of content update rates may include content update rates supported by one or more of hardware, software, a network connection, or firmware of the display 102 or the system 100. In one embodiment, the predefined list of content update rates may include specific content update rates based on content type. For example, each content type may include two or more different content update rates corresponding to whether or not the content is in a focus region. In one embodiment, the predefined list of content update rates may be stored in a storage device of the system 100.

In one embodiment, the content update rate component 118 selects content update rates of the display elements to satisfy an update effort constraint. For example, the update effort constraint may be a maximum area of the screen 102 or a maximum amount of memory that can be updated within a given update rate. The update effort constraint may reflect a hardware limitation, energy consumption limitation, data throughput limitation, or other limitation on the system 100 that should be met. In one embodiment, the refresh rate component 116 may increase at least one content update rate in the focus region and decrease at least one content update rate in one or more other display regions in order to satisfy the update effort constraint.

The content update component 118 may select content update rates based on the content type. For example, the content update component 118 may select the rates based on a predefined list of content update rates. In one embodiment, the content update component 118 is configured to select a higher content update rate when the content type comprises a dynamic content type, such as video, animations, or cycling advertisements. In one embodiment, the content update component 118 is configured to select a lower content update rate when the content type comprises a static content type. For example, static images or text may be updated with a lower content update rate than changing content. In one embodiment, even changing content, such as cycling advertisements, may have a reduced content update rate to allow a user to look at an advertisement longer. In one embodiment, the content update component 118 increases or decreases a content update rate when the focus region changes.

In one embodiment, the content update component 118 selects the content update rates based on a refresh rate. For example, the content update component 118 may select a content update rate that is the same as or slower than the refresh rate as there may be no need to update content more quickly than it will actually be displayed on the display 102. In one embodiment, the content update component 118 may select a content update rate up to a maximum of the refresh rate for the region in which the content will be displayed.

The content update component 118 may provide the content update rate(s) to the content component 104. For example, the content component 104 may update content for different regions of the display screen at different content rates. In one embodiment, the content update component 118 may determine different content update rates for each type of the content in the focus region and non-focus regions. The content component 104 may then update content for the different regions and the different content types at the specified rates.

With regard to FIGS. 5-9 example content update rate selection will be discussed. In FIG. 5 the content update component 118 may select a highest available content update rate for the focus region 502 so that the content component 104 will update drawn lines, or other information in the focus region as quickly as possible. Other regions of the window 500 may be updated at a minimum content update rate because little activity or change may occur outside the focus region 502. In FIG. 6, the content update component 118 may select a higher refresh rate in the focus region 604 than in the other regions. However, a maximum refresh rate may not be needed as text entry may not require an extremely high refresh rate to provide an impression of little or no delay to a user. In FIG. 7, the content update component 118 may select a higher content update rate for the first content area 706 because it lies within the focus region 702. For example, video may be displayed in the first content area 706. A lower content update rate may be assigned to text in the focus area 702 than the first content area 706 as text is more static than video. In one embodiment, the second content area 708, third content area 710, and/or text may be assigned reduced content update rates due to their location outside the focus region 702.

In FIG. 8, the content update component 118 may select an increased content update rate for the focus region 808. For example, the post option 804 may include an animated icon. Other regions of the interface 800 may be updated at a minimum rate because the content includes generally static content (e.g., text). In FIG. 9, the content update component 118 may select a higher content update rate for the focus region 910 than other regions of the interface 900. For example, a video may be displayed in the video display region 902 and an advertisement may be displayed in the advertisement region 904. Thus, a mobile device may retrieve images for the video (or for the advertisement) at a first rate while content in the other portions of the interface 900 is updated at a second, slower, rate.

Selecting different refresh rates or content update rates for different regions of the display 102 may provide significant benefit to improve operation of computing systems and displays. For example, energy savings may result from refreshing display elements and/or processing data to update content less frequently. Similarly, memory usage may be reduced as content in or outside the focus region may be updated at a lower frequency. Because a reduced frequency is needed, fewer images may be requested or accessed for storage prior to display. Similarly, network usage may be reduced as content at other locations may be requested less frequently. Furthermore, because refresh rates and content update rates may vary, resources may be allocated to regions where a user is focusing while regions outside of focus have fewer sources allocated. For example, when a user is staring at a touch screen, the user's experience may be most significantly affected by where the user is looking and/or touching. Regions currently outside of focus may be neglected somewhat, or have reduced allocation of resources, without being noticed by the user. As an example, a 240 Hz refresh rate (or content update rate) may be used for a focus region while a 60 Hz rate is used in other regions.

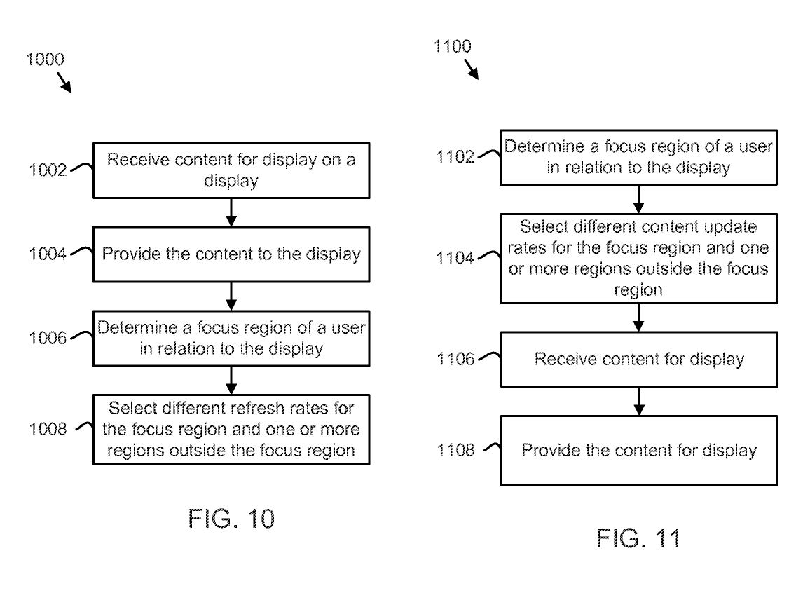

FIG. 10 is a schematic flow chart diagram illustrating a method 1000 for refreshing the display 102. The method 1000 may be performed by the system 100 of FIG. 1.

The method 1000 begins and the content component 104 receives 1002 content for display on the display 102. In one embodiment, the display 102 is configured to selectively display information with refresh rates that vary across a plurality of display regions of a display screen. The refresh rates include a frequency at which display elements within the plurality of display regions are refreshed. The content component 104 provides 1004 the content to the display 102.

The focus region component 106 determines 1006 a focus region for a user. For example, the focus region component 106 may detect or predict which area of the display 102 the user is looking at. The focus region component 106 may determine 1006 the focus region based on a gaze direction of the user, a location of an input object (e.g., determined based on a touch on a touch screen), a location of an input indicator, or the like. Similarly, the focus region component 106 determines 1006 the focus region by predicting, based on a current interface, current context, previous actions, or which area the user is likely to be focusing on.

The refresh rate component 116 selects 1008 refresh rates for display elements in a plurality of display regions. In one embodiment, the refresh rate component 116 selects 1008 the refresh rates such that a refresh rate in the focus region is different than a refresh rate in one or more other display regions of the plurality of display regions. The refresh rate component 116 may provide the refresh rates to the display 102. For example, the display 102 may refresh the display elements based on the refresh rates selected 1008 by the refresh rate component 116.

FIG. 11 is a schematic flow chart diagram illustrating a method 1100 for updating content on the display 102. The method 1100 may be performed by the system 100 of FIG. 1.

The method 1100 begins and the focus region component 106 determines 1102 a focus region of a user in relation to a display screen. The focus region component 106 may determine 1102 the focus region by detecting or predicting where the user is likely looking. For example, the focus region component 106 may detect a gaze direction, detect an input object, or determine a location of an input indicator.

The content update component 118 selects 1104 content update rates for a plurality of display regions of the display screen. In one embodiment, the content update rate in the focus region is different than a content update rate in one or more other display regions of the display screen. The content component 104 receives 1106 content for display. In one embodiment, the content component 104 updates the content based on the content update rates selected 1104 by the content update component 118. The content component 104 provides 1108 the content to the display 102.

This disclosure has been made with reference to various example embodiments. However, those skilled in the art will recognize that changes and modifications may be made to the embodiments without departing from the scope of the present disclosure. For example, various operational steps, as well as components for carrying out operational steps, may be implemented in alternate ways depending upon the particular application or in consideration of any number of cost functions associated with the operation of the system; e.g., one or more of the steps may be deleted, modified, or combined with other steps.

Additionally, as will be appreciated by one of ordinary skill in the art, principles of the present disclosure, including components, may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create a means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof are intended to cover a non-exclusive inclusion, such that a process, a method, an article, or an apparatus that comprises a list of elements does not include only those elements but may include other elements not expressly listed or inherent to such process, method, system, article, or apparatus.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A display system comprising:
a display comprising a display screen of a display;
a focus region component configured to determine a focus region of a user in relation to the display screen, wherein the focus region comprises a region of the display screen at which a user is likely looking;
a content update component configured to select content update rates for a plurality of display regions of the display screen, wherein the plurality of display regions comprise the focus region, wherein a content update rate in the focus region is different than a content update rate in one or more other display regions of the plurality of display regions of the display screen; and
a content component configured to receive content for display on the display screen and to provide the content to the display, wherein the display is configured to display the content in a plurality of display regions of the display screen, and wherein the content component is configured to update the content based on the content update rates.

2. The display system of claim 1, wherein the focus region component comprises a gaze sensor.

3. The display system of claim 1, wherein the content update component is configured to select the content update rates of the display elements to satisfy an update effort constraint.

4. The display system of claim 3, wherein the content update component is configured to increase at least one content update rate in the focus region and to decrease at least one content update rate in the one or more other display regions in order to satisfy the update effort constraint.

5. The display system of claim 1, wherein the content update component is configured to select the content update rates from a predefined list of update rates.

6. The display system of claim 1, wherein the content update component is configured to identify a content type of the content and wherein the content update component is configured to select the content update rates based on the content type.

7. The display system of claim 6, wherein the content update component is configured to select a higher content update rate when the content type comprises a dynamic content type.

8. The display system of claim 7, wherein the dynamic content type comprises video.

9. The display system of claim 7, wherein the dynamic content type comprises cycling advertisements.

10. The display system of claim 6, wherein the content update component is configured to select a lower content update rate when the content type comprises a static content type.

11. The display system of claim 10, wherein the content update component is configured to increase the content update rate from the lower content update rate when the focus region changes.

12. The display system of claim 10, wherein the static content type comprises text.

13. The display system of claim 1, wherein the display comprises a touch screen display comprising one or more of a capacitive touch screen and a pressure sensitive touch screen.

14. The display system of claim 13, wherein the touch screen display comprises a multi-touch screen.

15. The display system of claim 1, wherein the focus region component comprises an input object detection component, wherein the input object detection component is configured to detect a location of an input object comprising one or more of a finger or a stylus, and wherein the focus region component determines the focus region based on the location of the input object.

16. The display system of claim 1, wherein the focus region component determines the focus region based on the location of an input indicator displayed on the display screen.

17. The display system of claim 16, wherein the input indicator comprises a text cursor.

18. The display system of claim 16, wherein the input indicator comprises a mouse pointer.

19-34. (canceled)

35. The display system of claim 1, wherein the display system comprises one or more of a tablet computing device and a smartphone.

36. The display system of claim 1, further comprising a refresh rate component configured to select refresh rates of display elements in the plurality of display regions, wherein the refresh rate component selects the refresh rates such that a refresh rate in the focus region is different than a refresh rate in one or more other display regions of the plurality of display regions.

37. A method comprising:
determining a focus region of a user in relation to a display screen of a display, wherein the focus region comprises a region of a display screen at which a user is likely looking;
selecting content update rates for a plurality of display regions of the display screen, wherein the plurality of display regions comprise the focus region, wherein a content update rate in the focus region is different than a content update rate in one or more other display regions of the plurality of display regions of the display screen;
receiving content for display on the display screen, wherein the display is configured to display the content in a plurality of display regions of the display screen, and wherein the content component is configured to update the content based on the content update rates; and
providing the content to a display comprising the display screen.

38-54. (canceled)

55. The method of claim 37, wherein the plurality of display regions comprise a plurality of static display regions, wherein the display screen is logically or operationally divided into the plurality of static display regions.

56. The method of claim 37, wherein the plurality of display regions comprise a plurality of dynamic display regions, wherein the method further comprises determining a shape and location of one or more of the dynamic display regions on the display screen based on the focus region.

57. The method of claim 56, wherein one or more of the plurality of dynamic display regions comprise an asymmetrical shape.

58. The method of claim 57, wherein one or more of the plurality of dynamic display regions with the asymmetrical shape comprise a width greater than a height.

59. The method of claim 57, wherein one or more of the plurality of dynamic display regions with the asymmetrical shape comprise a longer dimension along a direction of movement or predicted movement of one or more of an input object and an input indicator.

60. The method of claim 37, wherein selecting the content update rates comprises selecting the content update rate in the focus region to be higher than the content update rate in the one or more other display regions of the plurality of display regions.

61. The method of claim 60, wherein selecting the content update rates comprises selecting a content update rate to update advertisements displayed in the focus region more frequently than advertisements displayed in the one or more other display regions.

62. The method of claim 60, wherein selecting the content update rates comprises selecting a content update rate to update contents of a word processing document displayed near an input indicator more frequently than contents of the word processing document displayed in one or more other display regions away from the input indicator.

63. The method of claim 37, wherein selecting the content update rates comprises selecting the content update rate in the focus region to be less than the content update rate in the one or more other display regions of the plurality of display regions.

64. The method of claim 63, wherein the display screen comprises a touch screen and wherein the focus region comprises a region corresponding to a touch by an input object.

65-71. (canceled)

72. One or more computer-readable storage media having collectively stored thereon executable instructions that, when executed by one or more processors of a computer system, cause the computer system to:
determine a focus region of a user in relation to a display screen of a display, wherein the focus region comprises a region of a display screen at which a user is likely looking;
select content update rates for a plurality of display regions of the display screen, wherein the plurality of display regions comprise the focus region, wherein a content update rate in the focus region is different than a content update rate in one or more other display regions of the plurality of display regions of the display screen;
receive content for display on the display screen, wherein the display is configured to display the content in a plurality of display regions of the display screen, and wherein the content component is configured to update the content based on the content update rates; and
provide the content to a display comprising the display screen.

73-99. (canceled)

100. The computer-readable storage media of claim 72, wherein executable instruction further cause the computing system to predict a future focus location and wherein selecting the content update rates comprises selecting the content update rates of the display regions based on the future focus location.

101. The computer-readable storage media of claim 100, wherein the future focus location comprises a location where an input object or input indicator has previously been located.

102. The computer-readable storage media of claim 100, wherein the future focus location comprises a location corresponding to a previous touch on a touch screen.

103. The computer-readable storage media of claim 100, wherein the future focus location comprises a location corresponding to a predicted future touch on the touch screen.

104. The computer-readable storage media of claim 100, wherein the future focus location comprises a location corresponding to a predicted movement of a stylus.

105. The computer-readable storage media of claim 100, wherein the future focus location comprises a location corresponding to a predicted movement of an input indicator.

106. (canceled)
